(19) United States
(12) Patent Application Publication
(10) Pub. No.: US 2026/0012670 A1
(43) Pub. Date: Jan. 8, 2026

(54) VIDEO PLAYBACK METHOD

(71) Applicant: Beijing Bytedance Network Technology Co., Ltd., Shijingshan District, Beijing (CN)

(72) Inventors: Yifan YANG, Beijing (CN); Ankang HOU, Beijing (CN); Haiqing TAO, Beijing (CN); Hailin WEN, Beijing (CN)

(21) Appl. No.: 18/864,220

(22) PCT Filed: May 9, 2023
(86) PCT No.: PCT/CN2023/092899

§ 371 Date: Nov. 8, 2024

(30) Foreign Application Priority Data
May 9, 2022 (CN) 202210500761.8

(51) Int. Cl. H04N 21/25; H04N 21/231; H04N 21/239

(52) U.S. Cl. CPC H04N 21/251; H04N 21/23106; H04N 21/2393

(57) ABSTRACT

Embodiments of the present disclosure relate to the technical field of video processing, and provide a video playback method. The video playback method is applied to a terminal device, and includes: sending video recommendation request information to a server in response to a video playback operation; receiving video recommendation response information sent from the server, which comprises a download address of at least one recommended video and playback data of a first video; parsing the video recommendation response information to obtain the playback data of the first video; and starting video playback based on the playback data of the first video.

### CROSS-REFERENCE TO RELATED APPLICATIONS

The present disclosure is based on and claims priority of Chinese application for invention number 202210500761.8, filed on May 9, 2022, the disclosure of which is hereby incorporated into this disclosure by reference in its entirety.

### TECHNICAL FIELD

This disclosure relates to the field of video recommendation technology, in particular to a video playback method and apparatus.

### BACKGROUND

With the rapid development of Internet technology and intelligent electronic devices, video playback as a practical function of electronic devices has been preferred by more and more people, and more and more users watch videos on electronic devices. However, there are a great number of videos with various contents, making it difficult for users to quickly find the videos they are interested in from a large number of video resources. As a result, delivering video to users through recommendations based on user preferences has become a very common way of video delivery.

In related technologies, the implementation of delivering videos to users through recommendations comprises: receiving, by a terminal device, a user's video playback operation and then sending a video recommendation request to a recommendation server; after receiving the video recommendation request sent from the terminal device, generating, by the recommendation server, recommendation information containing a video download address based on a recommendation algorithm and returning the recommendation information to the terminal device; then downloading, by the terminal device, a video from a corresponding video resource server based on the recommendation information before starting to play the video.

### SUMMARY

Embodiments of the present disclosure provide the following technical solution.

In a first aspect, some embodiments of the present disclosure provide a video playback method applicable to a terminal device, comprising: sending video recommendation request information to a server in response to a video playback operation; receiving video recommendation response information sent from the server, which comprises a download address of at least one recommended video and playback data of a first video; parsing the video recommendation response information to obtain the playback data of the first video; and starting video playback based on the playback data of the first video.

In a second aspect, some embodiments of the present disclosure provide a video playback method applicable to a server, comprising:

receiving video recommendation request information sent from a terminal device; obtaining a download address of at least one recommended video and playback data of a first video; generating video recommendation response information based on the download address of at least one recommended video and the playback data of the first video; sending the video recommendation response information to a terminal device, for parsing the video recommendation response information to obtain the playback data of the first video and starting video playback based on the playback data of the first video.

In a third aspect, some embodiments of the present disclosure provide a terminal device, comprising: a sending unit for sending video recommendation request information to a server in response to a video playback operation; a receiving unit for receiving video recommendation response information sent from the server, which comprises a download address of at least one recommended video and playback data of a first video; a processing unit for parsing the video recommendation response information to obtain the playback data of the first video; a playback unit for starting video playback based on the playback data of the first video.

In a fourth aspect, some embodiments of the present disclosure provide a server, comprising: a receiving unit for receiving video recommendation request information sent from a terminal device; an obtaining unit for obtaining a download address of at least one recommended video and playback data of a first video; a generating unit for generating video recommendation response information based on the download address of at least one recommended video and the playback data of the first video; a sending unit for sending the video recommendation response information to a terminal device, for parsing the video recommendation response information to obtain the playback data of the first video and starting video playback based on the playback data of the first video.

In a fifth aspect, some embodiments of the present disclosure provide an electronic device, comprising: a memory for storing a computer program; and a processor that, when executing the computer program, causes the electronic device to implement the video playback method according to any of the above embodiments.

In a sixth aspect, some embodiments of the present disclosure provide a computer-readable storage medium stored thereon a computer program that, when executed by a computing device, causes the computing device to implement the video playback method according to any of the above embodiments.

In a seventh aspect, some embodiments of the present disclosure provide a computer program product that, when running on a computer, causes the computer to implement the video playback method according to any of the above embodiments.

### BRIEF DESCRIPTION OF THE DRAWINGS

Herein, the accompanying drawings, which are incorporated in and constitute a part of this specification, illustrate embodiments of the present disclosure and, together with the description, serve to explain the principles of the present disclosure.

In order to more clearly explain the embodiments of the present disclosure or the technical solutions in the prior art, a brief introduction will be given below for the drawings required to be used in the description of the embodiments or the prior art. It is obvious that, for a person skilled in the art, he or she may also acquire other drawings according to such drawings on the premise that no inventive effort is involved.

FIG. 1 is a diagram showing a scenario architecture of a video playback method provided by some embodiments of the present disclosure;

FIG. 2 is a first flowchart of the video playback method provided by some embodiments of the present disclosure;

FIG. 3 is a second flowchart of the video playback method provided by some embodiments of the present disclosure;

FIG. 4 is a schematic structure diagram of a terminal device provided by some embodiments of the present disclosure;

FIG. 5 is a schematic structure diagram of a server provided by some embodiments of the present disclosure;

FIG. 6 is a schematic diagram showing the hardware structure of an electronic device provided in some embodiments of the present disclosure.

### DETAILED DESCRIPTION

In order to better understand the above objects, features and advantages of the present disclosure, the scheme of the present disclosure will be further described below. It should be noted that, in the case of no conflict, the embodiments and the features of the embodiments of the present disclosure may be combined with each other.

Many specific details are set forth in the following description to facilitate a full understanding of the present disclosure, but the present disclosure can also be implemented in other ways different from those described herein. Obviously, embodiments described in the description are only some embodiments of the present disclosure, and are not all of embodiments thereof.

In the present disclosed embodiments, words such as “as an illustration” or “for example” are used to provide examples, illustrations, or explanations. Any embodiments or designs described with “as an illustration” or “for example” in the embodiments of the present disclosure should not be construed as being more preferred or advantageous than other embodiments or designs. In particular, the use of words such as “as an illustration” or “for example” is intended to present relevant concepts in a particular way. Moreover, in the description of the embodiments of the present disclosure, unless otherwise indicated, the phrase “a plurality of” means “two or more”.

In related technologies, when a terminal device receives a user's video playback operation, the terminal device needs to obtain recommendation information containing a video download address from the recommendation server, and then download a video from a video resource server based on the video download address in order to play the video. However, the processes of obtaining recommendation information from the recommendation server and downloading a video from the video resource server each involve network latency and consume transmission time. The network latency and transmission time involved in the two processes above can cause a long delay in video playback at the terminal device, which greatly affects the user's user experience.

In view of this, some embodiments of the present disclosure provide a video playback method and apparatus, capable of reducing the amount of video playback latency at a terminal device.

First of all, a scenario architecture of a video playback method provided by some embodiments of the present disclosure will be described below.

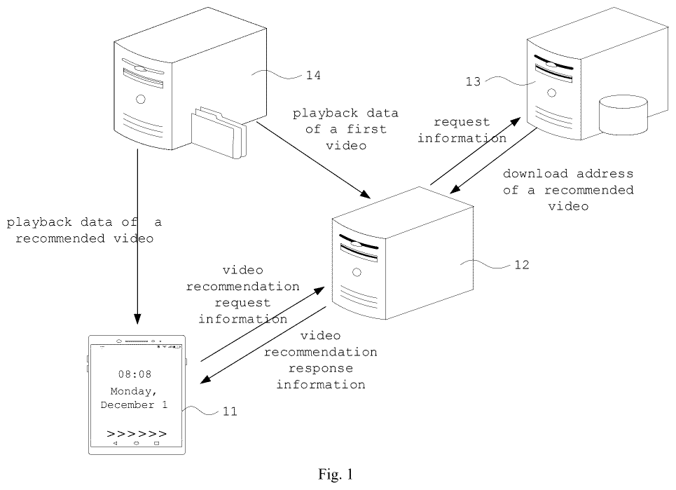

Referring to FIG. 1, the scenario architecture of the video playback method provided by some embodiments of the present disclosure comprises: a terminal device 11, a server 12, a recommendation server 13 and a resource server 14.

The terminal device 11 has a video playback application installed thereon, and can play a video via the video playback application in response to a user input; the server 12 can provide video playback data to the terminal device 11 in response to a request from the terminal device; the recommendation server 13 stores a predefined recommendation algorithm that can determine a recommended video in response to a recommendation request, and return a download address of the recommended video; the resource server 14 stores playback data of all videos, and other devices (terminal devices or servers) can obtain video playback data of a corresponding video from the resource server based on a video download address.

When the terminal device 11 receives an operation input from a user to control a player for video playback, it sends video recommendation request information to the server 12. When the server 12 receives the video recommendation request information sent from the terminal device 11, it first sends request information to the recommendation server 13 to request the recommendation server 13 to return a recommended video, and receives a download address of at least one recommended video sent from the recommendation server 13, and then, obtains playback data of a first video from the resource server 14 based on the download address of at least one recommended video, and generate video recommendation response information based on the download address of at least one recommended video and the playback data of the first video, which is then returned to the terminal device 11. After receiving the video recommendation response information, the terminal device 11 obtains the playback data of the first video carried in the video recommendation response information, and starts video playback based on the playback data of the first video. The terminal device 11 also obtains playback data of at least one recommended video from the resource server 14 based on the download address of at least one recommended video, and performs subsequent video playback based on the playback data of the at least one recommended video.

The terminal device 11 in the embodiments of the present disclosure may be a terminal device, such as a mobile phone, tablet computer, laptop, ultra mobile personal computer (UMPC), netbook, personal digital assistant (PDA), smart watch, or smart bracelet. The terminal device 11 may also be other types of terminal devices, and the type of the terminal device is not limited in the embodiments of the present disclosure. The server 12 in some embodiments of the present disclosure may be an application server. For example, the terminal device 11 receives an operation to control launching of application A installed on the terminal device 11 for video playback, and the server 12 may be a server of application A.

It should be noted that in the scenario architecture shown in FIG. 1, the server 12, the recommendation server 13, and the resource server 14 are shown as independent hardware devices. However, embodiments of the present disclosure are not limited thereto. In some embodiments, two or more hardware devices of the server 12, the recommendation server 13, and the resource server 14 are integrated into a single hardware device. For example, the server 12 and the recommendation server 13 can be integrated into one hardware device. In addition, the resource server 14 may be a single server or a cluster of servers.

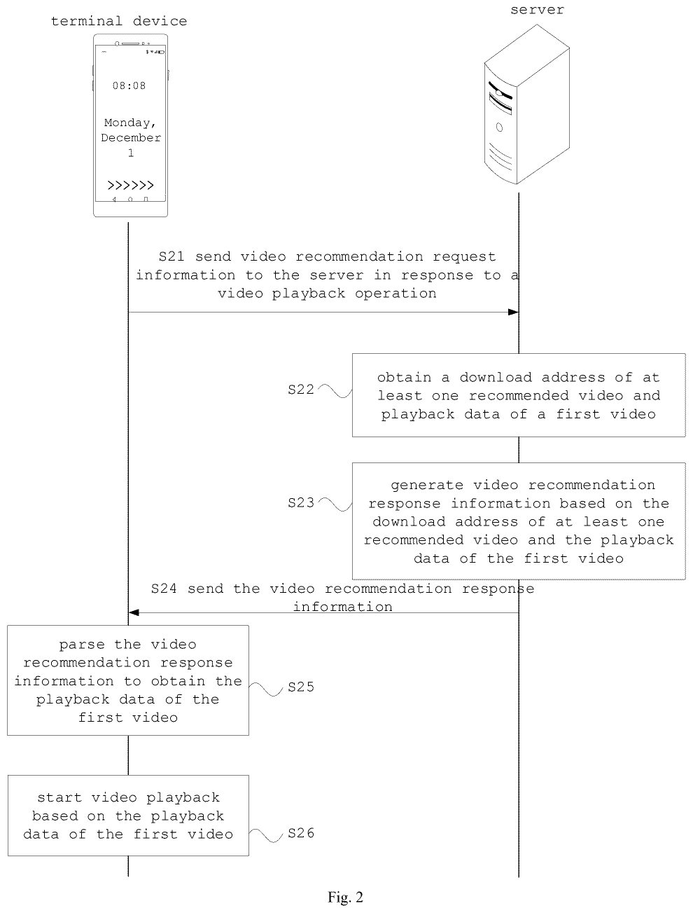

Based on the above content, some embodiments of the present embodiments provide a video playback method. As shown in FIG. 2, the video playback method comprises steps S21 to S26.

In S21, a terminal device sends video recommendation request information to a server in response to a video playback operation.

Correspondingly, the server receives the video recommendation request information sent from the terminal device.

The video playback operation in some embodiments can be an operation for launching a video playback application, for example, an input to an icon of the video playback application or a voice input for launching the video playback application. The video playback operation in some embodiments can also be an input for switching a video being played by the video playback application, for example, a slide-down input on a video playback interface of the terminal device. In addition, the video playback operation may be specifically a user click on a virtual control, a voice command input by a user, or a specific gesture input by a user. In some embodiments of the present disclosure, the specific gesture may be any one of a single click gesture, a slide gesture, a pressure sensing gesture, a long press gesture, an area-varying gesture, a double press gesture, or a double click gesture.

It should be noted that the video recommendation request information can also carry identification information of the terminal device and/or a user logged on to the terminal device, so that the server can make video recommendations based on the identification information of the terminal device and/or the user logged on to the terminal device.

In S22, the server obtains a download address of at least one recommended video and playback data of a first video.

In some embodiments, the terminal device may send request information carrying identification information of the terminal device and/or the user logged on to the terminal device to a recommendation server, so that the recommendation server can determine a recommended video based on a preset recommendation algorithm and return a download address of the recommended video to the server.

In some embodiments, the first video may be one of the at least one recommended videos. For example, the first video is the first one of the recommended videos.

In some embodiments, the first video may also be a video cached by the server corresponding to the terminal device or the user logged on to the terminal device. That is, the server caches videos for each user or terminal device, and when it receives video recommendation request information sent from a terminal device, it obtains playback data corresponding to the first video based on the cached data.

In some embodiments, the playback data of the first video comprises playback data corresponding to all video frames of the first video. That is, the playback data of the first video contains all the playback data of the first video.

In some embodiments, the playback data of the first video comprises playback data corresponding to a preset number of video frames from a beginning of the first video. That is, the playback data of the first video only contains a portion of the playback data of the first video.

In S23, the server generates video recommendation response information based on the download address of at least one recommended video and the playback data of the first video.

That is, the video recommendation response information generated by the server not only comprises the download address of at least one recommended video, but also the playback data of the first video.

In S24, the server sends the video recommendation response information to the terminal device.

Correspondingly, the terminal device receives the video recommendation response information sent from the server.

In S25, the terminal device parses the video recommendation response information to obtain the playback data of the first video.

That is, the terminal device extracts the playback data of the first video from the video recommendation response information.

In S26, the terminal device starts video playback based on the playback data of the first video.

The video playback method provided in some embodiments comprise after sending, by a terminal data, video recommendation request information to a server in response to a video playback operation, receiving video recommendation response information sent from the server including a download address of at least one recommended video and playback data of a first video; and then parsing the video recommendation response information to obtain the playback data of the first video and starting video playback based on the playback data of the first video. According to the video playback method provided according to some embodiments, since the video recommendation response information received after sending video recommendation request information to the server comprises the playback data of the first video, the playback data of the first video can be obtained to start video playback based on the playback data of the first video in this embodiment. Compared to the method in the related technologies in which, after receiving a download address of a recommended video sent from the server, the recommended video is first downloaded before starting video playback, the method of the present embodiments allows video playback to start with just one network request, thereby reducing network latency and transmission time. Therefore, the embodiments of the present disclosure can reduce the video playback delay of the terminal device.

It should also be noted that in the related technologies, during the video playback process, the terminal device has to make two network requests (one to request the download address of the recommended video and the other to request the playback data of the recommended video), and both network requests have a certain probability of failure, and any failure in the network requests will cause the failure of video playback. Therefore, in the related technologies, the probability of video playback failure is relatively high. According to some embodiments of the present disclosure, the terminal can start video playback with just one network request. Therefore, the method of some embodiments can also reduce the probability of video playback failure.

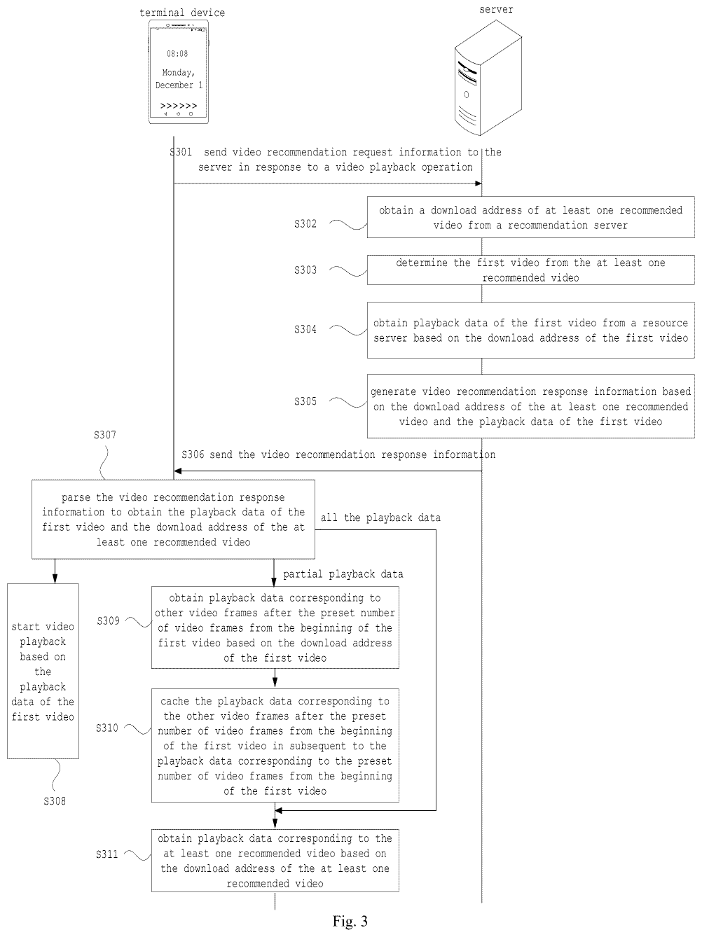

Some embodiments of the present disclosure provide another video playback method comprising the following steps, as shown in FIG. 3

In S301, a terminal device sends video recommendation request information to a server in response to a video playback operation.

Correspondingly, the server receives the video recommendation request information sent from the terminal device.

In S302, the server obtains a download address of at least one recommended video from a recommendation server.

In some embodiments, step S302 (obtaining, by the server, a download address of at least one recommended video from a recommendation server) may comprise the following steps a to d:

Step a: sending, by the server, request information carrying an identification of a target user to the recommendation server.

The target user is a user logged on to the terminal device, the request information being used to request the recommendation server to return a download address of a corresponding recommended video.

Step b: obtaining, by the recommendation server, attribute information of the target user based on the identification of the target user.

The attribute information of the target user can comprise the target user's video viewing history, the target user's video viewing preferences, and other information.

Step c: determining, by the recommendation server, at least one recommended video based on the attribute information of the target user and a predefined recommendation algorithm.

The above step c (determining, by the recommendation server, at least one recommended video based on the attribute information of the target user and a predefined recommendation algorithm) may comprise:
determining, by the recommendation server, a recommendation degree for each video in a video resource repository based on the attribute information of the target user and the predefined recommendation algorithm, sorting the videos in descending order according to their recommendation degrees, and determining the top n videos from the sorting result as the at least one recommended video, where n is a positive integer.

Step d: sending, by the recommendation server, a download address of the at least one recommended video to the server.

In S303, the server determines the first video from the at least one recommended video.

In some embodiments, S303 (determining, by the server, the first video from the at least one recommended video) comprises:
determining, by the server, the first one of the at least one recommended video as the first video.

That is, a video with the highest recommendation ranking (a video with the highest degree of recommendation) among the at least one recommended video is determined as the first video.

In S304, the server obtains playback data of the first video from a resource server based on the download address of the first video.

Since the server obtains a download address of each of the at least one recommended video from the recommendation server, and the first video is determined by the server from the at least one recommended video, the server can obtain a download address of the first video, and then obtain playback data of the first video from a resource server based on the download address of the first video.

In some embodiments, S304 (obtaining, by the server, playback data of the first video from a resource server based on the download address of the first video) comprises: obtaining, by the server, playback data corresponding to all video frames of the first video from the resource server based on the download address of the first video.

That is, the server gets the complete playback data corresponding to all the content of the first video from the resource server.

In some embodiments, in response to that the server has obtained playback data corresponding to all video frames of the first video from the resource server based on the download address of the first video, the terminal device no longer needs to obtain the playback data of the first video from the resource server based on the download address of the first video. Therefore, the method provided in some embodiments may further comprise: removing the download address of the first video from the download address of the at least one recommended video.

In some embodiments, S304 (obtaining, by the server, playback data of the first video from a resource server based on the download address of the first video) comprises: obtaining, by the server, playback data corresponding to a preset number of video frames from the beginning of the first video from the resource server based on the download address of the first video.

That is, the server only gets playback data corresponding to a portion of the content of the first video from the resource server.

In case that the server obtains playback data corresponding to a preset number of video frames from the beginning of the resource server based on the download address of the first video, the terminal device also needs to obtain playback data corresponding to other video frames after the preset number of video frames from the beginning of the resource server based on the download address of the first video. Therefore, the download address of the first video is maintained in the download address of the at least one recommended video.

In S305, the server generates video recommendation response information based on the download address of the at least one recommended video and the playback data of the first video.

In some embodiments, S305 (generating, by the server, video recommendation response information based on the download address of the at least one recommended video and the playback data of the first video) comprises the following steps 1 and 2.

Step 1: merging the download address of the at least one recommended video and the playback data of the first video in a preset format to generate merged data.

The preset format may be a format negotiated between the server and the terminal device, or is configured by operations and maintenance personnel.

Step 2: generating the video recommendation response information based on the merged data.

In S306, the server sends the video recommendation response information to the terminal device.

Correspondingly, the terminal device receives the video recommendation response information sent from the server.

In S307, the terminal device parses the video recommendation response information to obtain the playback data of the first video and the download address of the at least one recommended video.

In some embodiments, the terminal device can parse the video recommendation response information according to the preset format to obtain the playback data of the first video and the download address of the at least one recommended video.

As described above, in some embodiments, the download address of the at least one recommended video comprises the download address of the first video. In some embodiments, the download address of the at least one recommended video does not comprise the download address of the first video.

In S308, the terminal device starts video playback based on the playback data of the first video.

In step S304, in response to that the server obtains playback data corresponding to a preset number of video frames (partial playback data of the first video) from the beginning of the first video from the resource server based on the download address of the first video, the following steps S309 to S312 are performed. However, in response to that the server obtains playback data corresponding to all video frames of the first video (full playback data of the first video) from the resource server based on the download address of the first video, steps S309 and S310 are skipped to directly execute steps S311 and S312 as follows.

In S309, the terminal device obtains playback data corresponding to other video frames after the preset number of video frames from the beginning of the first video based on the download address of the first video.

In S310, the terminal device caches the playback data corresponding to the other video frames after the preset number of video frames from the beginning of the first video in subsequent to the playback data corresponding to the preset number of video frames from the beginning of the first video.

In S311, the terminal device obtains playback data corresponding to the at least one recommended video based on the download address of the at least one recommended video.

In S312, the terminal device caches the playback data corresponding to the at least one recommended video in subsequent to the playback data of the first video.

It should be noted that the above steps S309 to S312 can be executed synchronously with S308, that is, the terminal device starts video playback based on the playback data of the first video while obtaining subsequent playback data.

The video playback method provided in some embodiments comprises after sending, by a terminal data, video recommendation request information to a server in response to a video playback operation, receiving video recommendation response information from the server comprising a download address of at least one recommended video and playback data of a first video; and then parsing the video recommendation response information to obtain the playback data of the first video and starting video playback based on the playback data of the first video. According to the video playback method provided in some embodiments, since the video recommendation response information received after sending video recommendation request information to the server comprises the playback data of the first video, the playback data of the first video can be obtained to start video playback based on the playback data of the first video in this embodiment. Compared to the method in the related technologies in which, after receiving a download address of a recommended video sent from the server, the recommended video is first downloaded before starting video playback, the method of the present embodiments allows video playback to start with just one network request, thereby reducing network latency and transmission time. Therefore, the embodiments of the present disclosure can reduce the video playback delay of the terminal device.

Network requests have a certain probability of failure, and if the network request in the embodiments of the present disclosure fails (the terminal device fails to send video recommendation request information to the server or the terminal device fails to receive video recommendation response information sent from the server), the terminal device will be unable to start video playback. To address this issue, some embodiments of the present disclosure provide a solution for error recovery, specifically comprising: in response to that the terminal device cannot receive the video recommendation response information sent from the server within a preset time, the terminal device will read playback data of a second video stored in a preset storage space and start video playback based on the playback data of the second video.

That is, in response to that the server does not respond for a long time after the terminal device sends video recommendation request information to the server, the terminal device will read cached playback data of a second video and start video playback based on the playback data of the second video. This can further shorten the video playback delay of the terminal device when a network request error occurs.

When the terminal starts video playback based on the playback data of the first video, the terminal may also encounter problems such as missing or losing necessary data such as the bit rate and/or resolution of the first video in the playback data. Some embodiments also provide an error recovery method for such situations, specifically comprising: in response to that there is an error in playing the first video based on the playback data of the first video, reading playback data of a second video stored in a preset storage space, and starting video playback based on the playback data of the second video.

That is, In case that video playback cannot be started based on the playback data of the first video even though the video recommendation response information returned from the server has been received, cached playback data of the second video is read and video playback is started based on the playback data of the second video so that the video playback delay of the terminal device can be further reduced when an error occurs in obtaining playback data via a network request.

After obtaining playback data of a recommended video normally, the video playback method provided in some embodiments of the present disclosure further comprises: updating the second video based on the playback data of the recommended video.

For example, at a certain point, in response to that the terminal device has received the playback data of recommended video A, but the video playback on the terminal device is stopped by the user without playing recommended video A, the second video can be updated with video A.

Based on the same inventive concept, as an implementation of the above method, a terminal device and a server are further provided by some embodiments of the present disclosure corresponding to the above method embodiment. For ease of reading, the contents of the above method embodiments will not be explained in detail here, but it should be clarified that all the contents of the above method embodiments can be achieved in the terminal device and server of the following embodiments.

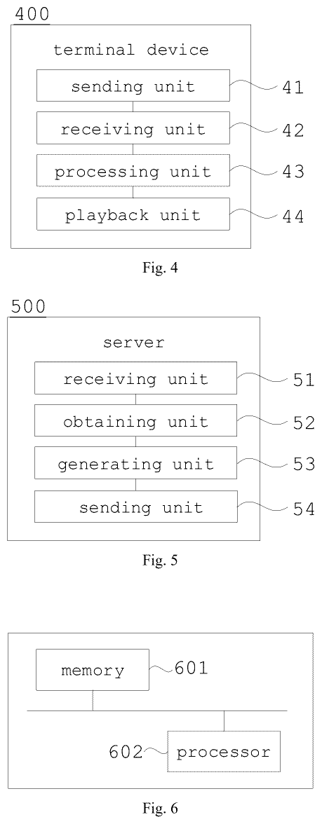

Some embodiments of the present disclosure provide a terminal device. FIG. 4 is a schematic structure diagram of the terminal device. As shown in FIG. 4, the terminal device 400 comprises: a sending unit 41 for sending video recommendation request information to a server in response to a video playback operation; a receiving unit 42 for receiving video recommendation response information sent from the server, which comprises a download address of at least one recommended video and playback data of a first video; a processing unit 43 for parsing the video recommendation response information to obtain the playback data of the first video; a playback unit 44 for starting video playback based on the playback data of the first video.

In some embodiments, the processing unit 43 is further used for, after receiving video recommendation response information sent from the server, parsing the video recommendation response information to obtain the download address of the at least one recommended video; obtaining playback data corresponding to the at least one recommended video based on the download address of the at least one recommended video; and caching the playback data corresponding to the at least one recommended video in subsequent to the playback data of the first video.

In some embodiments, the playback data of the first video comprises playback data corresponding to a preset number of video frames from the beginning of the first video, the video recommendation response information further comprising a download address of the first video.

The processing unit 43 is further used for parsing the video recommendation response information to obtain the download address of the first video; obtaining playback data corresponding to other video frames after the preset number of video frames from the beginning of the first video based on the download address of the first video; caching the playback data corresponding to the other video frames after the preset number of video frames from the beginning of the first video in subsequent to the playback data corresponding to the preset number of video frames from the beginning of the first video.

In some embodiments, the playback unit 44 is further used for, in response to that video recommendation response information sent from the server is not received within a preset time, reading playback data of a second video stored in a preset storage space and starting video playback based on the playback data of the second video.

In some embodiments, the playback unit 44 is further used for, in response to that there is an error in playing the first video based on the playback data of the first video, reading playback data of a second video stored in a preset storage space, and starting video playback based on the playback data of the second video.

Some embodiments of the present disclosure provide a server. FIG. 5 is a schematic structure diagram of the server. As shown in FIG. 5, the server 500 comprises: a receiving unit 51 for receiving video recommendation request information sent from a terminal device; an obtaining unit 52 for obtaining a download address of at least one recommended video and playback data of a first video; a generating unit 53 for generating video recommendation response information based on the download address of the at least one recommended video and the playback data of the first video; a sending unit 54 for sending the video recommendation response information to the terminal device, for parsing the video recommendation response information to obtain the playback data of the first video and starting video playback based on the playback data of the first video.

In some embodiments, the obtaining unit 52 is particularly used for obtaining the download address of the at least one recommended video from a recommendation server; determining the first video from the at least one recommended video; obtaining playback data of the first video from a resource server based on the download address of the first video.

In some embodiments, the obtaining unit 52 is particularly used for determining the first one of the at least one recommended video as the first video.

In some embodiments, the obtaining unit 52 is particularly used for obtaining playback data corresponding to a preset number of video frames from the beginning of the first video from the resource server based on the download address of the first video.

In some embodiments, the generating unit 53 is particularly used for merging the download address of the at least one recommended video and the playback data of the first video in a preset format to generate merged data; generating the video recommendation response information based on the merged data.

The terminal device and server provided in some embodiments can perform the video playback method provided in the above method embodiments, and its principle and technical effect are similar to that of the method embodiments, which will not be repeated here.

The above units may be implemented as software components running on one or more general-purpose processors, or as hardware performing specific functions or combinations thereof, such as programmable logic devices and/or specialized integrated circuits. In some embodiments, these units can be embodied in the form of software products that can be stored in non-volatile storage media that enable computing devices (such as personal computers, servers, network devices, mobile terminals, etc.) to implement the methods described in the embodiments of the present disclosure. In other embodiments, the above units may also be implemented on a single device or distributed across multiple devices. The functions of these units can be combined or further divided into multiple subunits.

Based on the same inventive concept, some embodiments of the present disclosure further provide an electronic device. FIG. 6 is a schematic structural diagram of an electronic device provided in some embodiments of the present disclosure. As shown in FIG. 6, the electronic device provided in some embodiments comprises a memory 601 for storing a computer program instructions; and a processor 602 that, when executing the computer program instructions, perform the video playback method provided by any of the above embodiments.

Based on the same inventive concept, some embodiments of the present disclosure further provides a computer-readable storage medium stored thereon a computer program that, when executed by a processor, causes a computing device to implement the video playback method provided by any of the above embodiments.

Based on the same inventive concept, some embodiments of the present disclosure further provide a computer program product that, when running on a computer, causes the computing device to implement the video playback method provided by any of the above embodiments.

Some embodiments of the present disclosure further provide a computer program including instructions that, when executed by a processor, cause the processor to perform the video playback method provided by any of the above embodiments.

One skilled in the art should understand that, the embodiments of the present disclosure may be provided as a method, a system, a computer program product, or a computer program. Therefore, embodiments of the present disclosure can take the form of an entirely hardware embodiment, some entirely software embodiments or some embodiments containing both hardware and software elements. Moreover, the present disclosure may take the form of a computer program product embodied on one or more computer-usable storage media having computer-usable program code embodied therein.

The processors may be central processing units (CPUs) or other general-purpose processors, digital signal processors (DSPs), application specific integrated circuits (ASICs), field programmable gate arrays (FPGAs) or other programmable logic devices, or discrete hardware components such as discrete gates or transistors. The general-purpose processor may be a microprocessor, or the processor may be any conventional processor or the like.

The memory may comprise non-permanent memory in a computer-readable medium, random access memory (RAM) and/or non-volatile memory, such as read only memory (ROM) or flash RAM. The memory is an example of a computer-readable medium.

The computer-readable media comprise permanent and non-permanent, removable and non-removable storage media. The storage medium can realize information storage by any method or technology. The information can be computer-readable instructions, data structures, program modules, or other data. Examples of computer storage media comprise, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, CD-ROM, digital versatile disc (DVD) or other optical storage, magnetic cassettes, magnetic tape, magnetic disk storage or other magnetic storage devices, or any other non-transmission media that can be used to store information that can be accessed by computing devices. According to the definition herein, computer-readable media does not comprise transitory media, such as modulated data signals and carrier waves.

It shall be noted that: the above embodiments are merely illustration of the technical solution of this disclosure, but are not limitation thereof. Although this disclosure has been described in detail with reference to the above embodiments, those ordinary skilled in the art shall understand: the technical solutions recited in the various embodiments described above may be modified or some technical features thereof or all the technical features may be substituted equivalently, such modifications or substitutions do not deviate the nature of the technique from the scope of the technique embodied in the embodiments according to this disclosure.

1. A video playback method, comprising:
sending video recommendation request information to a server in response to a video playback operation;
receiving video recommendation response information sent from the server, which comprises a download address of at least one recommended video and playback data of a first video;
parsing the video recommendation response information to obtain the playback data of the first video; and
starting video playback based on the playback data of the first video.

2. The video playback method according to claim 1, further comprising:
after receiving the video recommendation response information sent from the server, parsing the video recommendation response information to obtain the download address of the at least one recommended video;
obtaining playback data corresponding to the at least one recommended video based on the download address of the at least one recommended video; and
caching the playback data corresponding to the at least one recommended video in subsequent to the playback data of the first video.

3. The video playback method according to claim 1, wherein the playback data of the first video comprises playback data corresponding to a preset number of video frames from a beginning of the first video, and the video recommendation response information further comprises a download address of the first video, and the video playback method further comprises:
parsing the video recommendation response information to obtain the download address of the first video;
obtaining playback data corresponding to other video frames after the preset number of video frames from the beginning of the first video based on the download address of the first video; and
caching the playback data corresponding to the other video frames after the preset number of video frames from the beginning of the first video in subsequent to the playback data corresponding to the preset number of video frames from the beginning of the first video.

4. The video playback method according to claim 1, further comprising:
in response to that the video recommendation response information sent from the server is not received within a preset time, reading playback data of a second video stored in a preset storage space and starting video playback based on the playback data of the second video.

5. The video playback method according to claim 1, further comprising:
in response to that there is an error in playing the first video based on the playback data of the first video, reading playback data of a second video stored in a preset storage space, and starting video playback based on the playback data of the second video.

6. A video playback method, comprising:
receiving video recommendation request information sent from a terminal device;
obtaining a download address of at least one recommended video and playback data of a first video;
generating video recommendation response information based on the download address of the at least one recommended video and the playback data of the first video; and
sending the video recommendation response information to a terminal device for parsing the video recommendation response information to obtain the playback data of the first video and starting video playback based on the playback data of the first video.

7. The video playback method according to claim 6, wherein the obtaining the download address of the at least one recommended video and the playback data of the first video comprises:
obtaining the download address of the at least one recommended video from a recommendation server;
determining the first video from the at least one recommended video; and
obtaining the playback data of the first video from a resource server based on the download address of the first video.

8. The video playback method according to claim 7, wherein the determining the first video from the at least one recommended video comprises:
determining first of the at least one recommended video as the first video.

9. The video playback method according to claim 7, wherein the obtaining the playback data of the first video from the resource server based on the download address of the first video comprises:
obtaining playback data corresponding to a preset number of video frames from a beginning of the first video, from the resource server, based on the download address of the first video.

10. The video playback method according to claim 6, wherein the generating the video recommendation response information based on the download address of the at least one recommended video and the playback data of the first video comprises:
merging the download address of the at least one recommended video and the playback data of the first video in a preset format to generate merged data; and
generating the video recommendation response information based on the merged data.

11-12. (canceled)

13. An electronic device, comprising: a memory for storing a computer program; and a processor that, when executing the computer program, causes the electronic device to implement the video playback method according to claim 1.

14. A non-transitory computer-readable storage medium stored thereon computer program instructions that, when executed by a computing device, causes the computing device to implement a video playback method, comprising:
sending video recommendation request information to a server in response to a video playback operation;
receiving video recommendation response information sent from the server, which comprises a download address of at least one recommended video and playback data of a first video;
parsing the video recommendation response information to obtain the playback data of the first video; and
starting video playback based on the playback data of the first video.

15-16. (canceled)

17. An electronic device, comprising: a memory for storing a computer program; and a processor that, when executing the computer program, causes the electronic device to implement the video playback method according to claim 2.

18. An electronic device, comprising: a memory for storing a computer program; and a processor that, when executing the computer program, causes the electronic device to implement the video playback method according to claim 3.

19. An electronic device, comprising: a memory for storing a computer program; and a processor that, when executing the computer program, causes the electronic device to implement the video playback method according to claim 4.

20. A non-transitory computer-readable storage medium stored thereon computer program instructions that, when executed by a computing device, causes the computing device to implement the video playback method according to claim 6.

21. The non-transitory computer-readable storage medium according to claim 14, wherein the video playback method further comprising:
after receiving the video recommendation response information sent from the server, parsing the video recommendation response information to obtain the download address of the at least one recommended video;
obtaining playback data corresponding to the at least one recommended video based on the download address of the at least one recommended video; and
caching the playback data corresponding to the at least one recommended video in subsequent to the playback data of the first video.

22. The non-transitory computer-readable storage medium according to claim 14, wherein the playback data of the first video comprises playback data corresponding to a preset number of video frames from a beginning of the first video, the video recommendation response information further comprises a download address of the first video, and the video playback method further comprises:
parsing the video recommendation response information to obtain the download address of the first video;
obtaining playback data corresponding to other video frames after the preset number of video frames from the beginning of the first video based on the download address of the first video; and
caching the playback data corresponding to the other video frames after the preset number of video frames from the beginning of the first video in subsequent to the playback data corresponding to the preset number of video frames from the beginning of the first video.

23. The non-transitory computer-readable storage medium according to claim 14, wherein the video playback method further comprising:
in response to that the video recommendation response information sent from the server is not received within a preset time, reading playback data of a second video stored in a preset storage space and starting video playback based on the playback data of the second video.

24. The non-transitory computer-readable storage medium according to claim 14, wherein the video playback method further comprising:
in response to that there is an error in playing the first video based on the playback data of the first video, reading playback data of a second video stored in a preset storage space, and starting video playback based on the playback data of the second video.
